(19) United States
(12) Patent Application Publication
(10) Pub. No.: US 2026/0169644 A1
(43) Pub. Date: Jun. 18, 2026

(54) MEMORY DEVICE AND METHOD OF OPERATION THEREOF

(71) Applicant: Samsung Electronics Co., Ltd., Suwon-si (KR)

(72) Inventors: Youngmin JO, Suwon-si (KR); Jung-June PARK, Suwon-si (KR); Chiweon YOON, Suwon-si (KR)

(21) Appl. No.: 19/354,648

(22) Filed: Oct. 9, 2025

(30) Foreign Application Priority Data
Dec. 16, 2024 (KR) 10-2024-0187446

(51) Int. Cl. G06F 3/06

(52) U.S. Cl. CPC G06F 3/0632; G06F 3/0604; G06F 3/0679

(57) ABSTRACT

A memory device may include a calibration circuit connected to a ZQ pad and configured to perform ZQ calibration and generate a ZQ code, a transmission circuit configured to provide a termination resistance to a DQ pad based on the ZQ code in a first mode and to block the termination resistance from the DQ pad in a second mode, and at least one sub-circuit configured to generate a status signal of the memory device, and the calibration circuit may be configured to initiate the ZQ calibration based on the status signal.

### CROSS-REFERENCE TO RELATED APPLICATION(S)

This application claims the benefit of Korean Patent Application No. 10-2024-0187446, filed on Dec. 16, 2024, in the Korean Intellectual Property Office, the disclosure of which is incorporated herein by reference in its entirety.

### BACKGROUND

Semiconductor memory is widely used to store data in various electronic devices such as computers and wireless communication devices. To access to data stored in semiconductor memory, at least one stored state of the semiconductor memory may be read or sensed. In addition, to store data, a state of semiconductor memory may be maintained or changed.

Semiconductor memory may receive signals transmitted from outside through an input pad and transmit a signal generated inside to outside through an output pad. Meanwhile, to reduce delay time to transmit a signal as an operation speed of an electronic device increases, it is desired to effectively transmit and receive a signal in an interface of semiconductor memory.

### SUMMARY

In general, the present disclosure is directed toward a memory device performing calibration without a separate command and an operation method thereof.

According to some implementations, the present disclosure is directed to a memory device that includes a calibration circuit connected to a ZQ pad and configured to perform ZQ calibration and generate a ZQ code, a transmission circuit configured to provide a termination resistance to a DQ pad based on the ZQ code in a first mode and to block the termination resistance from the DQ pad in a second mode, and at least one sub-circuit configured to generate a status signal indicating a state of the memory device. The calibration circuit may be configured to initiate the ZQ calibration based on the status signal.

According to some implementations, the present disclosure is directed to an operation method of a memory device that includes generating a ZQ code by performing ZQ calibration based on a state of a ZQ pad, providing, in a first mode, a termination resistance based on the ZQ code to a DQ pad, blocking, in a second mode, the termination resistance from the DQ pad, and generating a status signal indicating a state of the memory device. Generating the ZQ code may include initiating the ZQ calibration based on the status signal.

According to some implementations, the present disclosure is directed to a memory device that includes a calibration circuit connected to a ZQ pad and configured to perform ZQ calibration and generate a ZQ code and a transmission circuit configured to provide a termination resistance to a DQ pad based on the ZQ code in a first mode and to block the termination resistance from the DQ pad in a second mode. The calibration circuit may be configured to perform the ZQ calibration in the first mode.

### BRIEF DESCRIPTION OF THE DRAWINGS

Example implementations will be more clearly understood from the following detailed explanation, taken in conjunction with the accompanying drawings.

FIG. 1 is a block diagram illustrating an example of a system according to some implementations.

FIG. 2 is a block diagram illustrating an example of a storage system according to some implementations.

FIG. 3 is a block diagram illustrating examples of a memory controller and a memory device of FIGS. 1 and 2 according to some implementations.

FIG. 4 is a block diagram illustrating examples of a memory controller and a memory device according to some implementations.

FIG. 5 is a timing diagram of an example of an operation of a memory device according to some implementations.

FIG. 6 is a block diagram illustrating an example of a memory device according to some implementations.

FIG. 7 is a block diagram illustrating an example of a memory device according to some implementations.

FIG. 8 is a block diagram illustrating an example of a memory device according to some implementations.

FIG. 9 is a block diagram illustrating an example of a memory device according to some implementations.

FIG. 10 is a block diagram illustrating an example of a memory device according to some implementations.

FIG. 11 is a timing diagram of an example of an operation of a memory device according to some implementations.

FIG. 12 is a flowchart of an example of an operation method of a memory device according to some implementations.

FIG. 13 is a flowchart of an example of an operation method of a memory device according to some implementations.

FIG. 14 is a block diagram of an example of a device according to some implementations.

### DETAILED DESCRIPTION

Hereinafter, example implementations will be explained in detail with reference to the accompanying drawings.

Terms used in the present disclosure are selected, as much as possible, from general terms that are widely used at present while taking into consideration the functions of the present disclosure, but these terms may be replaced by other terms based on intentions of those skilled in the art, judicial precedent, the advent of new technologies, or the like. Also, in a particular case, terms that are arbitrarily selected by the applicant of the present disclosure may be used. In this case, the meanings of these terms will be described in detail in corresponding description parts of the disclosure. Accordingly, it should be noted that the terms used herein should be construed based on practical meanings thereof and the whole content of the present disclosure.

In the present disclosure, when an element is referred to as “comprising” or “including” another element, the element should not be understood as excluding other elements so long as there is no special conflicting description, and the element may further include at least one other element. In addition, terms such as “. . . part” and “. . . module” described in the present disclosure mean a unit processing at least one function or operation, which can be implemented by hardware or software, or a combination of hardware and software.

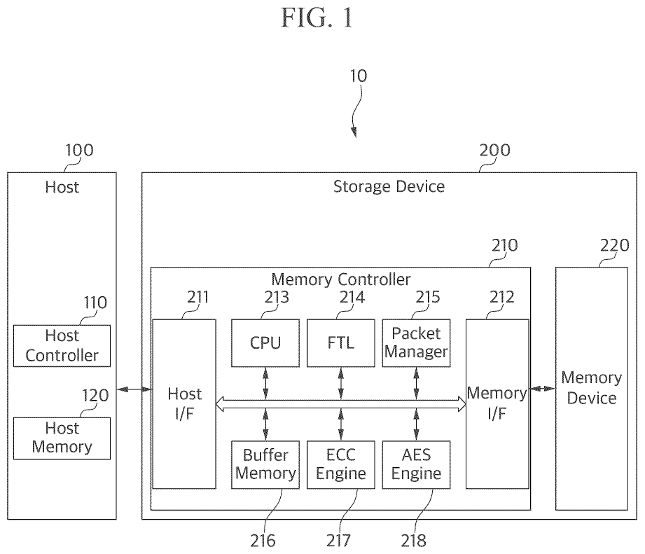

FIG. 1 is a block diagram illustrating an example of a system according to some implementations. The block diagram of FIG. 1 illustrates a host-storage system 10.

In FIG. 1, the host-storage system 10 may include a host 100 and a storage device 200. The host 100 may include a host controller 110 and a host memory 120. The host controller 110 may generate data to store in the storage device 200 and process data received from the storage device 200. The host memory 120 may function as a buffer memory to temporarily store data to be transmitted to the storage device 200, or data received from the storage device 200.

In some implementations, each of the host controller 110 and the host memory 120 may be embodied as a separate semiconductor chip. In some implementations, the host controller 110 and the host memory 120 may be integrated into the same semiconductor chip. As an example, the host controller 110 may be one of numerous modules that is included in an application processor, and the application processor may be implemented as a system on chip (SoC). In addition, the host memory 120 may be an embedded memory that is included in the application processor, or a memory device (or a memory module) that is placed outside of the application processor.

The host controller 110 may manage an operation to store data (for example, program data) of a buffer area in a memory device 220 or to store data (for example, read data) of the memory device 220 in the buffer area.

The storage device 200 may include a memory controller 210 and the memory device 220. The storage device 200 may include storage media to store data in response to a request from the host 100. For example, the storage device 200 may include at least one of a solid state drive (SSD), an embedded memory, and a detachable external memory. If the storage device 200 is the SSD, the storage device 200 may be a device that complies with a standard of a non-volatile memory express NVMe.

When the storage device 200 is the embedded memory or the external memory, the storage device 200 may be a device that complies with a standard of universal flash storage (UFS) or embedded multi-media card (eMMC). The host 100 and the storage device 200 may generate and transmit a packet in accordance with each adopted standard protocol.

When the memory device 220 of the storage device 200 includes a flash memory, the flash memory may include a two-dimensional (2D) NAND memory array or a three-dimensional (3D) (or vertical) NAND (VNAND) memory array. As another example, the storage device 200 may also include other various types of memory devices. For example, the storage device 200 may include magnetic random access memory (MRAM), spin-transfer torque MRAM (STT-MRAM), conductive bridging RAM (CBRAM), ferroelectric RAM (FeRAM), phase RAM (PRAM), resistive RAM, and other various types of memories.

The memory controller 210 may include a host interface (I/F) 211, a memory interface (I/F) 212 and a central processing unit (CPU) 213. In addition, the memory controller 210 may further include a flash translation layer (FTL) 214, a packet manager 215, a buffer memory 216, an error correction code (ECC) engine 217, and an advanced encryption standard (AES) engine 218.

The memory controller 210 may further include a working memory into which the FTL 214 is loaded, and data program and read operations for a memory device may be controlled by the CPU 213 executing the FTL 214.

In some implementations, the host I/F 211 may transmit and receive a packet to and from the host 100. A packet transmitted from the host 100 to the host I/F 211 may include a command and/or data to be programmed on the memory device 220, and a packet transmitted from the host I/F 211 to the host 100 may include a response to a command and/or data read from the memory device 220.

The memory I/F 212 may transmit data to be programmed on the memory device 220 to the memory device 220, or receive data read from the memory device 220 from the memory device 220. In some implementations, the memory I/F 212 may be implemented to comply with a standard protocol such as Toggle or Open NAND Flash Interface (ONFI).

The FTL 214 may perform various functions such as an address mapping, a wear-leveling, and a garbage collection. The address mapping operation may refer to an operation of changing a logical address received from the host 100 to a physical address that is used to actually store data within the memory device 220. The wear-leveling may prevent a predetermined block from being excessively deteriorated by allowing blocks within the memory device 220 to be uniformly used, and for example, may be implemented through firmware balancing erase counts of physical blocks. The garbage collection may secure capacity available within the memory device 220 through a manner of copying valid data of a block to a new block and then erasing the existing block.

The packet manager 215 may generate a packet according to a protocol of an interface agreed with the host 100 or parse a variety of information from a packet received from the host 100. In addition, the buffer memory 216 may temporarily store data to be programmed on the memory device 220 or data that is read from the memory device 220. The buffer memory 216 may be a configuration that is provided within the memory controller 210 as illustrated in FIG. 1 or in some implementations, may be disposed outside of the memory controller 210.

The ECC engine 217 may perform a function to detect and correct an error for read data that is read from the memory device 220. For example, the ECC engine 217 may generate parity bits for write data to be written on the memory device 220, and the parity bits may be stored within the memory device 220 together with the write data. When data is read from the memory device 220, the ECC engine 217 may detect and correct an error of read data by using parity bits that are read together with the read data from the memory device 220 and may output the read data whose error is corrected.

The AES engine 218 may perform at least one of an encryption operation and a decryption operation for data that is inputted to the memory controller 210. In some implementations, the AES engine 218 may perform an encryption and/or a decryption operation by using a symmetric-key algorithm.

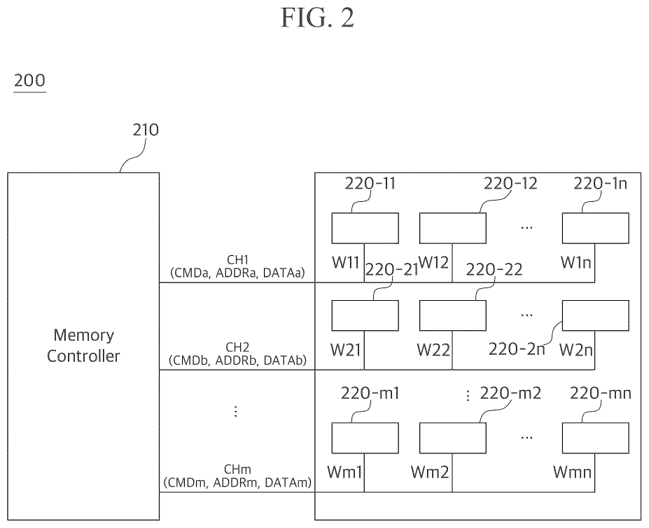

FIG. 2 is a block diagram illustrating an example of a storage system according to some implementations. FIG. 2 illustrates the storage device 200 as an example of the storage system. The storage device 200 of FIG. 2 may be an example of the storage device 200 of FIG. 1. The storage system may be referred to as a memory system.

In FIGS. 1 2, the storage device 200 may include the memory device 220 and the memory controller 210. The storage device 200 may support a plurality of channels CH1 to CHm, and for example, the storage device 200 may be implemented as a storage device such as an SSD. In some implementations, the memory device 220 may include a non-volatile memory device.

According to some implementations, the memory device 220 may be one or more. As an example, each of memory devices 220-11 to 220-mn and the memory controller 210 may be connected through the plurality of channels CH1 to CHm. Each of the memory devices 220-11 to 220-mn may be connected to one of the plurality of channels CH1 to CHm through a corresponding way. For example, memory devices 220-11 to 220-1n may be connected to a first channel CH1 through ways W11 to W1n, and memory devices 220-21 to 220-2n may be connected to a second channel CH2 through ways W21 to W2n. According to some implementations, each of the memory devices 220-11 to 220-mn may be implemented as any memory unit that may operate according to an individual instruction from the memory controller 210. For example, each of the memory devices 220-11 to 220-mn may be implemented as a chip or a die, but the present disclosure is not limited thereto.

The memory controller 210 may transmit and receive signals to and from the memory device 220 through the plurality of channels CH1 to CHm. For example, the memory controller 210 may transmit commands CMDa to CMDm, addresses ADDRa to ADDRm, and data DATAa to DATAm to the memory device 220 or receive the data DATAa to DATAm from the memory device 220 through the channels CH1 to CHm.

The memory controller 210 may select one of memory devices connected to a corresponding channel through each channel and transmit and receive signals to and from the selected memory device. For example, the memory controller 210 may select a memory device 220-11 among the memory devices 220-11 to 220-1n connected to the first channel CH1. The memory controller 210 may transmit a command CMDa, an address ADDRa, and data DATAa to the selected memory device 220-11 through the first channel CH1 or receive the data DATAa from the selected memory device 220-11.

The memory controller 210 may transmit and receive signals in parallel to and from the memory devices 220-11 to 220-mn through different channels. For example, the memory controller 210 may transmit a command CMDb to a memory device 220-21 through the second channel CH2 while transmitting the command CMDa to the memory device 220-11 through the first channel CH1. For example, the memory controller 210 may receive data DATAb from the memory device 220-21 through the second channel CH2 while receiving the data DATAa from the memory device 220-11 through the first channel CH1.

The memory controller 210 may control an overall operation of the memory device 220. The memory controller 210 may transmit a signal to the channels CH1 to CHm and control each of the memory devices 220-11 to 220-mn connected to the channels CH1 to CHm by transmitting a signal to the channels CH1 to CHm. For example, the memory controller 210 may control a selected one from the memory devices 220-11 to 220-1n by transmitting the command CMDa and the address ADDRa to the first channel CH1.

Each of the memory devices 220-11 to 220-mn may operate according to a control of the memory controller 210. For example, the memory device 220-11 may program the data DATAa according to the command CMDa, the address ADDRa, and the data DATAa provided to the first channel CH1. For example, the memory device 220-21 may read the data DATAb according to the command CMDb and an address ADDRb provided to the second channel CH2 and transmit the read data DATAb to the memory controller 210.

In FIG. 2, the memory devices 220-11 to 220-mn communicate with the memory controller 210 through m channels and are formed as n memory devices 220-11 to 220-mn corresponding to each channel. However, the number of channels and the number of memory devices connected to one channel may be changed in various manners.

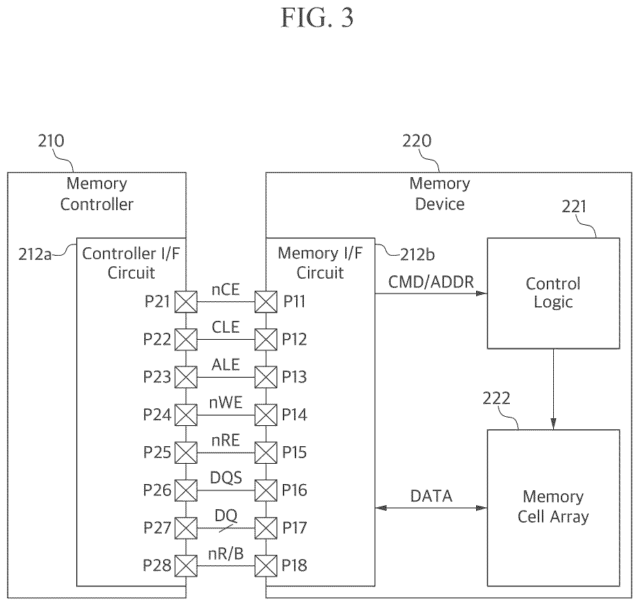

FIG. 3 is a block diagram illustrating examples of a memory controller and a memory device of FIGS. 1 and 2 according to some implementations. The memory I/F 212 in FIG. 1 may include a controller I/F circuit 212a of FIG. 3.

In FIG. 3, the memory device 220 may include a first pin P11, a second pin P12, a third pin P13, a fourth pin P14, a fifth pin P15, a sixth pin P16, a seventh pin P17, and an eighth pin P18, a memory I/F circuit 212b, a control logic circuit 221, and a memory cell array 222. In the present disclosure, a pin may also be referred to as a pad.

The memory device 220 in FIG. 1 may include the memory I/F circuit 212b. The memory I/F circuit 212b may receive a chip enable signal nCE from the memory controller 210 through the first pin P11. The memory I/F circuit 212b may transmit and receive signals to and from the memory controller 210 through the second to eighth pins P12 to P18 according to the chip enable signal nCE. For example, if the chip enable signal nCE is in an enable state (for example, a low level), the memory I/F circuit 212b may transmit and receive signals to and from the memory controller 210 through the second to eighth pins P12 to P18.

The memory I/F circuit 212b may receive a command latch enable signal CLE, an address latch enable signal ALE, and a write enable signal nWE from the memory controller 210 through the second to fourth pins P12 to P14. The memory I/F circuit 212b may receive a data signal DQ from the memory controller 210 through the seventh pin P17 or transmit the data signal DQ to the memory controller 210. A command CMD, an address ADDR, and data DATA may be transferred through the data signal DQ. For example, the data signal DQ may be transferred through a plurality of data signal lines. In this case, the seventh pin P17 may include a plurality of pins corresponding to a plurality of data signals.

The memory I/F circuit 212b may obtain the command CMD from the data signal DQ that is received in an enable interval (for example, a high level state) of the command latch enable signal CLE based on toggle timings of the write enable signal nWE. The memory I/F circuit 212b may obtain the address ADDR from the data signal DQ that is received in an enable interval (for example, a high level state) of the address latch enable signal ALE based on toggle timings of the write enable signal nWE.

According to some implementations, the write enable signal nWE may maintain a static state (for example, a high level or a low level) and toggle between the high level and the low level. For example, the write enable signal nWE may toggle in an interval where the command CMD or the address ADDR are transmitted. Accordingly, the memory I/F circuit 212b may obtain the command CMD or the address ADDR based on toggle timings of the write enable signal nWE.

The memory I/F circuit 212b may receive a read enable signal nRE from the memory controller 210 through the fifth pin P15. The memory I/F circuit 212b may receive a data strobe signal DQS from the memory controller 210 or transmit the data strobe signal DQS to the memory controller 210 through the sixth pin P16.

In a data DATA output operation of the memory device 220, the memory I/F circuit 212b may receive the read enable signal nRE that toggles through the fifth pin P15 before outputting the data DATA. The memory I/F circuit 212b may generate the data strobe signal DQS that toggles based on toggling of the read enable signal nRE. For example, the memory I/F circuit 212b may generate the data strobe signal DQS that begins to toggle after a predetermined delay (for example, tDQSRE) on the basis of a toggling starting time of the read enable signal nRE. The memory I/F circuit 212b may transmit the data signal DQ including the data DATA based on a toggle timing of the data strobe signal DQS. Accordingly, the data DATA may be arranged based on the toggle timing of the data strobe signal DQS and transmitted to the memory controller 210.

In a data DATA input operation of the memory device 220, when the data signal DQ including the data DATA is received from the memory controller 210, the memory I/F circuit 212b may receive the data strobe signal DQS toggling together with the data DATA from the memory controller 210. The memory I/F circuit 212b may obtain the data DATA from the data signal DQ based on a toggle timing of the data strobe signal DQS. For example, the memory I/F circuit 212b may obtain the data DATA by sampling the data signal DQ at a positive edge and a negative edge of the data strobe signal DQS.

The memory I/F circuit 212b may transmit a ready/busy output signal nR/B to the memory controller 210 through the eighth pin P18. The memory I/F circuit 212b may transmit state information of the memory device 220 to the memory controller 210 through the ready/busy output signal nR/B. When the memory device 220 is in a busy state (in other words, while internal operations of the memory device 220 are performed), the memory I/F circuit 212b may transmit the ready/busy output signal nR/B indicating the busy state to the memory controller 210. When the memory device 220 is in a ready state (in other words, when internal operations of the memory device 220 are not performed or completed), the memory I/F circuit 212b may transmit the ready/busy output signal nR/B indicating the ready state to the memory controller 210.

For example, while the memory device 220 is reading the data DATA from the memory cell array 222 in response to a page read instruction, the memory I/F circuit 212b may transmit the ready/busy output signal nR/B indicating the busy state (for example, a low level) to the memory controller 210. For example, while the memory device 220 is programming the data DATA on the memory cell array 222 in response to a program instruction, the memory I/F circuit 212b may transmit the ready/busy output signal nR/B indicating the busy state to the memory controller 210.

The control logic circuit 221 may control various operations of the memory device 220 in general. The control logic circuit 221 may receive a command/address CMD/ADDR obtained from the memory I/F circuit 212b. The control logic circuit 221 may generate control signals to control other elements of the memory device 220 according to the received command/address CMD/ADDR. For example, the control logic circuit 221 may generate various control signals to program the data DATA on the memory cell array 222 or to read the data DATA from the memory cell array 222.

The memory cell array 222 may store the data DATA obtained from the memory I/F circuit 212b according to a control of the control logic circuit 221. The memory cell array 222 may output the stored data DATA to the memory I/F circuit 212b according to a control of the control logic circuit 221.

The memory cell array 222 may include a plurality of memory cells. For example, the plurality of memory cells may be flash memory cells. However, the present disclosure is not limited thereto, and the memory cells may be a resistive random access memory (RRAM) cell, a ferroelectric random access memory (FRAM) cell, a phase change random access memory (PRAM) cell, a thyristor random access memory (TRAM) cell, and a magnetic random access memory (MRAM) cell. Hereinafter, example implementations of the present disclosure are described focusing on the memory cells being NAND flash memory cells.

The memory controller 210 may include a first pin P21, a second pin P22, a third pin P23, a fourth pin P24, a fifth pin P25, a sixth pin P26, a seventh pin P27, and an eighth pin P28, and the controller I/F circuit 212a. The first to eighth pins P21 to P28 may correspond to the first to eighth pins P11 to P18 of the memory device 220.

The controller I/F circuit 212a may transmit the chip enable signal nCE to the memory device 220 through the first pin P21. The controller I/F circuit 212a may transmit and receive signals to and from the memory device 220 selected through the chip enable signal nCE through the second to eighth pins P22 to P28.

The controller I/F circuit 212a may transmit the command latch enable signal CLE, the address latch enable signal ALE, and the write enable signal nWE to the memory device 220 through the second to fourth pins P22 to P24. The controller I/F circuit 212a may transmit the data signal DQ to the memory device 220 or receive the data signal DQ from the memory device 220 through the seventh pin P27.

The controller I/F circuit 212a may transmit the data signal DQ including the command CMD or the address ADDR together with the toggling write enable signal nWE to the memory device 220. The controller I/F circuit 212a may transmit the data signal DQ including the command CMD to the memory device 220 as the command latch enable signal CLE having an enable state is transmitted and transmit the data signal DQ including the address ADDR to the memory device 220 as the address latch enable signal ALE having an enable state is transmitted.

The controller I/F circuit 212a may transmit the read enable signal nRE to the memory device 220 through the fifth pin P25. The controller I/F circuit 212a may receive the data strobe signal DQS from the memory device 220 or transmit the data strobe signal DQS to the memory device 220 through a sixth pin P26.

In a data DATA output operation of the memory device 220, the controller I/F circuit 212a may generate the toggling read enable signal nRE and transmit the read enable signal nRE to the memory device 220. For example, the controller I/F circuit 212a may generate the read enable signal nRE changing into a toggle state from a static state (for example, a high level or a low level) before the data DATA is output. Accordingly, the toggling data strobe signal DQS may be generated based on the read enable signal nRE in the memory device 220. The controller I/F circuit 212a may receive the data signal DQ including the data DATA together with the toggling data strobe signal DQS from the memory device 220. The controller I/F circuit 212a may obtain the data DATA from the data signal DQ based on a toggle timing of the data strobe signal DQS.

In a data DATA input operation of the memory device 220, the controller I/F circuit 212a may generate the toggling data strobe signal DQS. For example, the controller I/F circuit 212a may generate the data strobe signal DQS changing into a toggle state from a static state (for example, a high level or a low level) before transmitting the data DATA. The controller I/F circuit 212a may transmit the data signal DQ including the data DATA to the memory device 220 based on toggle timings of the data strobe signal DQS.

The controller I/F circuit 212a may receive the ready/busy output signal nR/B from the memory device 220 through the eighth pin P28. The controller I/F circuit 212a may identify state information of the memory device 220 based on the ready/busy output signal nR/B.

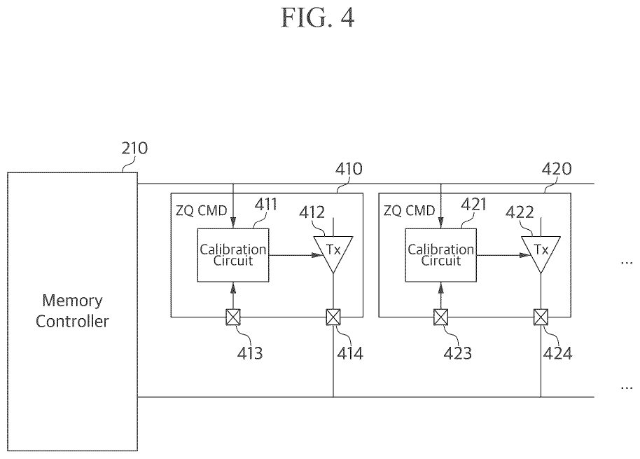

FIG. 4 is a block diagram illustrating examples of a memory controller and a memory device according to some implementations. In FIG. 4, the memory controller 210 and a first memory device 410 and a second memory device 420 connected to one channel are shown. In this case, the first memory device 410 and the second memory device 420 may be the memory device 220 described above through FIGS. 1 to 3.

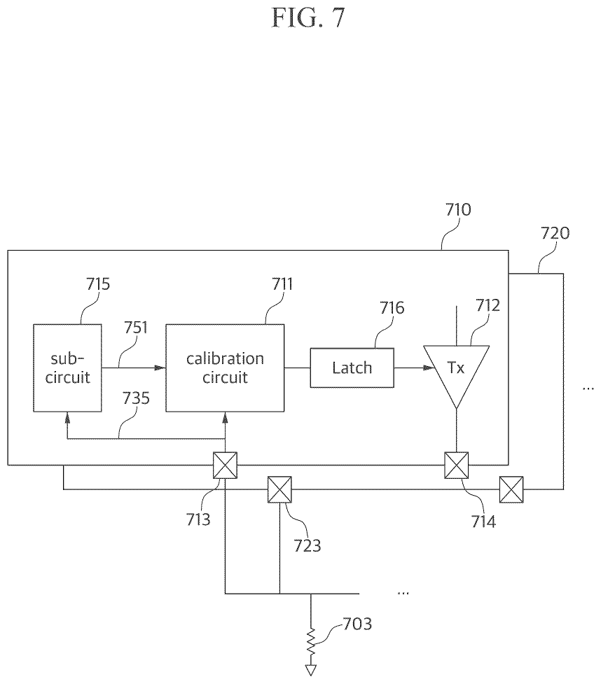

According to some implementations, the first memory device 410 may include a ZQ pad 413 and a DQ pad 414. The ZQ pad 413 may be connected to an external resistance (for example, 703 in FIG. 7) and be used to adjust a termination impedance. In some implementations, an end of the external resistance may be connected to a supply voltage VSS. The DQ pad 414 may be a pad where data is input or output. The DQ pad 414 may be connected to the memory controller 210 and a DQ pad 424 of the second memory device 420. In the present disclosure, the term “pad” may indicate a wide range of electrical interconnection to an integrated circuit. For example, a “pad” may include a pin described through FIG. 3 or another electrical contact point on an integrated circuit.

According to some implementations, the first memory device 410 may include a calibration circuit 411 and a transmission circuit 412. As an example, the calibration circuit 411 may be configured to generate a ZQ code by performing ZQ calibration by using the external resistance connected to the ZQ pad 413. For example, the calibration circuit 411 may repeatedly perform the ZQ calibration operation by using the external resistance and generate the ZQ code of n bits (n means a whole number greater than or equal to one).

According to some implementations, the transmission circuit 412 may include a DQ driver. For example, the DQ driver may determine a termination resistance of the DQ pad 414 based on the ZQ code. In other words, the termination resistance of the DQ pad 414 may be determined based on the ZQ code.

Likewise, the second memory device 420 may include a ZQ pad 423, the DQ pad 424, a calibration circuit 421, and a transmission circuit 422. Furthermore, since the first memory device 410 and the second memory device 420 are connected to one channel, a data output of the transmission circuit 422 through the DQ pad 424 may be limited while a data output of the transmission circuit 412 through the DQ pad 414 is performed.

The memory controller 210 may provide a ZQ command ZQ CMD to the first memory device 410 and the second memory device 420. For example, the memory controller 210 may identify a state requiring calibration, and when the calibration is required, provide the ZQ command ZQ CMD to the first memory device 410 and/or the second memory device 420. The calibration circuits 411 and 421 of the first memory device 410 and the second memory device 420 may perform the calibration in response to the ZQ command ZQ CMD.

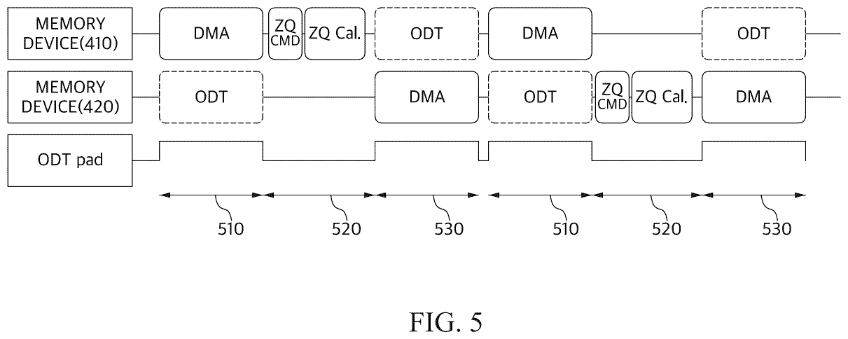

FIG. 5 is a timing diagram of an example of an operation of a memory device according to some implementations. In FIG. 5, while the first memory device 410 is performing a direct memory access DMA operation such as transmitting and receiving data to and from a DQ channel through a DQ pad by using a transmission circuit, an activated signal (for example, a high level) may be applied to an on-die termination (ODT) pad to reduce signal reflection inside the memory devices 410 and 420. In some implementations, each of the first memory device 410 and the second memory device 420 may include the ODT pad, and the memory controller 210 may instruct termination to be activated by applying the activated signal to the ODT pad. As illustrated in FIG. 5, while applying an inactivated signal (for example, a low level) to the ODT pad, the memory controller 210 may provide the ZQ command (ZQ CMD) to one of the first memory device 410 and the second memory device 420. When the ZQ command (ZQ CMD) is received to the first memory device 410, the calibration circuit of the first memory device 410 may perform ZQ calibration (ZQ Cal). When the ZQ command (ZQ CMD) is received to the second memory device 420, the calibration circuit of the second memory device 420 may perform ZQ calibration (ZQ Cal).

While a calibration circuit in one of the first memory device 410 and the second memory device 420 performs ZQ calibration 520, data transmission and reception through the DQ pads in the first memory device 410 and the second memory device 420 sharing the same DQ channel may be blocked. This is because while a termination resistance in the DQ pads is controlled by the ZQ calibration, the use of the DQ channel is limited. In addition, when the first memory device 410 performs a DMA operation 510, the data transmission and reception through the DQ pad in the second memory device 420 are blocked, and when the second memory device 420 performs the DMA operation 530, the data transmission and reception through the DQ pad in the first memory device 410 may be blocked.

In the memory device 410 and 420, the ZQ calibration may be set to be performed at predetermined intervals (for example, 128 milliseconds (ms)). As described above, while the ZQ calibration 520 is performed, the first memory device 410 and one or more second memory devices 420 sharing the same DQ channel may not perform another operation, and accordingly, data write and/or read latency for the first memory device 410 and the second memory device 420 may increase.

Hereinafter, a state where a signal of the ODT pad (or an ODT pin) is at a first level (for example, a high level) refers to a first mode, and a state where the signal of the ODT pad (or the ODT pin) is at a second level (for example, a low level) refers to a second mode.

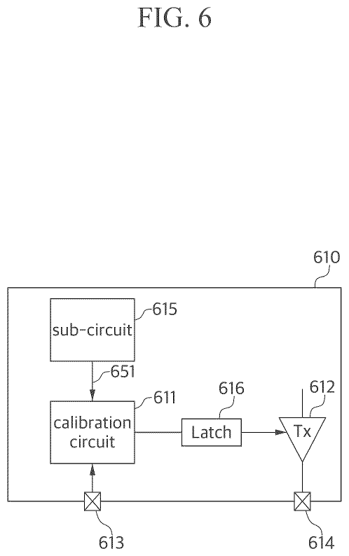

FIG. 6 is a block diagram illustrating an example of a memory device according to some implementations. In FIG. 6, a first memory device 610 may include a calibration circuit 611, a transmission circuit 612, a ZQ pad 613, a DQ pad 614, a sub-circuit 615, and a first latch 616. The first memory device 610 may be an example of the memory device 220 described through FIGS. 1 to 3, and the first memory device 610 may be a flash memory device.

In some implementations, the calibration circuit 611 may generate a ZQ code, and the first latch 616 may store the ZQ code. The first latch 616 may provide the stored ZQ code to the transmission circuit 612. In this case, the transmission circuit 612 may include the aforementioned DQ driver.

According to some implementations, at least one sub-circuit 615 may be configured to generate a status signal 651 of the first memory device 610. For example, at least one sub-circuit 615 may include a temperature sensor configured to sense a temperature of the first memory device 610. In this case, the sub-circuit 615 may generate the status signal 651 indicating the sensed temperature of the first memory device 610. The sub-circuit 615 may transmit the status signal 651 to the calibration circuit 611.

According to some implementations, the calibration circuit 611 may be configured to initiate ZQ calibration based on the status signal 651. For example, the calibration circuit 611 may compare a value of the status signal 651 to at least one reference value, and the calibration circuit 611 may initiate the ZQ calibration based on a comparison result of the value of the status signal 651 to at least one reference value. For example, the calibration circuit 611 may compare a temperature of the first memory device 610 corresponding to the value of the status signal 651 to at least one reference temperature. As an example, the reference temperature may be a temperature of the first memory device 610 directly after performing the latest ZQ calibration or a preset (or initially set) temperature. Subsequently, the calibration circuit 611 may determine whether to initiate the ZQ calibration based on the comparison result. For example, the calibration circuit 611 may determine to initiate the ZQ calibration when a temperature of the first memory device 610 differs from a reference temperature by a predetermined value or more.

According to some implementations, at least one sub-circuit 615 may include an oscillator generating an oscillating signal, and the oscillating signal may be used in an operation of the first memory device 610. According to some implementations, the oscillating signal may be a DQS (data strobe) signal, and the oscillator may be referred to as a DQS oscillator. The DQS signal may be used to synchronize an exact timing when the first memory device 610 transmits and receives data. In this case, a frequency of the oscillating signal may vary according to an environment including a temperature and a voltage of the oscillator included in the first memory device 610. As an example, the sub-circuit 615 may generate the status signal 651 indicating a state for example, a frequency of the oscillating signal of the first memory device 610. For example, the sub-circuit 615 may include a counter to measure the frequency of the oscillating signal. Accordingly, the status signal 651 may indicate a state change of the first memory device 610.

According to some implementations, the calibration circuit 611 may compare a value of the status signal 651 to at least one reference value. For example, the calibration circuit 611 may compare the frequency of the oscillating signal, the value of the status signal 651 to at least one reference frequency. As an example, the reference frequency may be a frequency of the oscillating signal directly after performing the latest ZQ calibration or a preset (or initially set) frequency. Subsequently, the calibration circuit 611 may determine whether to initiate ZQ calibration based on a comparison result. For example, the calibration circuit 611 may determine to initiate the ZQ calibration when a frequency of the oscillating signal (for example, the DQS signal) of the first memory device 610 differs from a reference frequency by a predetermined value or more. The calibration circuit 611 may be configured to initiate ZQ calibration based on the status signal 651.

Meanwhile, the calibration circuit 611 may be configured to initiate the ZQ calibration in response to a command received from outside of the first memory device 610 as described above with reference to FIG. 4. For example, the calibration circuit 611 may initiate the ZQ calibration in response to a ZQ calibration command received from a memory controller.

Furthermore, the explanation about the first memory device 610 may be similarly applied to a first memory device different from the first memory device 610.

FIG. 7 is a block diagram illustrating an example of a memory device according to some implementations. In FIG. 7, a sub-circuit 715 may be configured to generate a status signal 751 of a first memory device 710. For example, at least one sub-circuit 715 may be a voltage sensor configured to sense a voltage of a ZQ pad 713. In this case, the sub-circuit 715 may generate the status signal 751 indicating the sensed voltage of the ZQ pad 713 by sensing the voltage of the ZQ pad 713. The sub-circuit 715 may transmit the status signal 751 to a calibration circuit 711.

According to some implementations, the calibration circuit 711 may be configured to identify whether a second memory device 720 performs ZQ calibration based on a voltage of the ZQ pad 713. The ZQ pad 713 in the first memory device 710 and a ZQ pad 723 in the second memory device 720 may be connected in common to one end of an external resistance 703. As shown in FIG. 7, the other end of the external resistance 703 may be grounded. When the second memory device 720 performs the ZQ calibration for the external resistance 703, by a pull-up calibration operation and a pull-down calibration operation of the second memory device 720, a voltage may be applied to one end of the external resistance 703 to which the first memory device 710 is connected in parallel. Accordingly, when the second memory device 720 performs the ZQ calibration for the external resistance 703, the voltage of the ZQ pad 713 of the first memory device 710 may change. Conversely, when any of the memory devices 710 and 720 do not perform the ZQ calibration for the external resistance 703, the voltage of the ZQ pad 713 may be a voltage in a predefined range, for example, a ground voltage or a voltage close to zero. Accordingly, the calibration circuit 711 may identify whether the second memory device 720 performs the ZQ calibration based on the voltage of the ZQ pad 713.

As described above, the calibration circuit 711 may determine whether to initiate the ZQ calibration based on a temperature and/or a frequency of an oscillating signal (for example, the DQS signal) of the first memory device 710 obtained from the sub-circuit 615 of FIG. 6. When the calibration circuit 711 determines to initiate the ZQ calibration, whether the second memory device 720 performs the ZQ calibration may be identified based on the status signal 751 generated by at least one sub-circuit 715 and the ZQ calibration of the first memory device 710 may be determined to be initiated at the moment when the second memory device 720 does not perform the ZQ calibration.

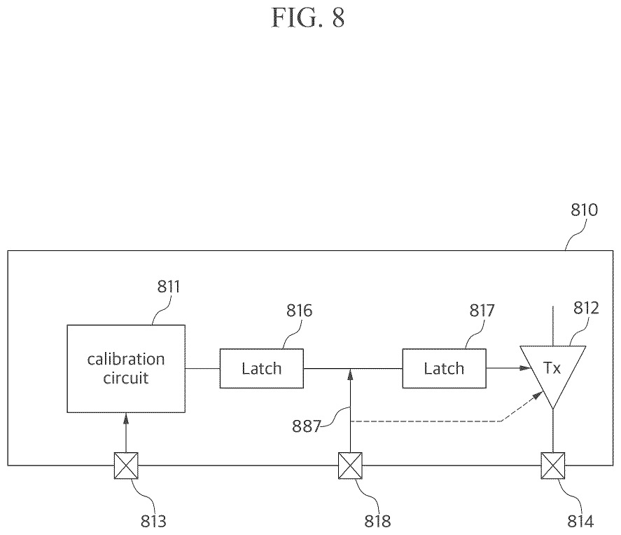

FIG. 8 is a block diagram illustrating an example of a memory device according to some implementations. In FIG. 8, a first memory device 810 may further include a first latch 816 configured to store a ZQ code (hereinafter, referred to as a first ZQ code) received from a calibration circuit 811 and a second latch 817 configured to store a ZQ code (hereinafter, referred to as a second ZQ code) provided to a transmission circuit 812. In this case, the second ZQ code may be updated to the first ZQ code in a second mode. After the second ZQ code stored in the second latch 817 is updated to the first ZQ code in a second mode, the second latch 817 may provide the updated second ZQ code, namely, the first ZQ code, to the transmission circuit 812.

In some implementations, the transmission circuit 812 may determine whether to switch to a first mode or the second mode based on a control signal 887 received through an ODT pad 818. As described above, while the first memory device 810 performs a DMA operation, such as transmitting data through a DQ pad 814, by using the transmission circuit 812, an activated control signal may be applied to the ODT pad to reduce a signal reflection within the first memory device 810 and another memory device. Accordingly, another memory device may identify whether the first memory device 810 performs the DMA operation through the control signal received through the ODT pad.

As an example, by identifying a state of the transmission circuit 812 through the control signal 887 of the ODT pad 818, whether the first memory device 810 is in the first mode or the second mode may be identified or whether to switch to the first mode may be determined. Specifically, when the control signal 887 of the ODT pad 818 is switched from a low level to a high level, the transmission circuit 812 may determine that the first memory device 810 or a second memory device is switched to the first mode.

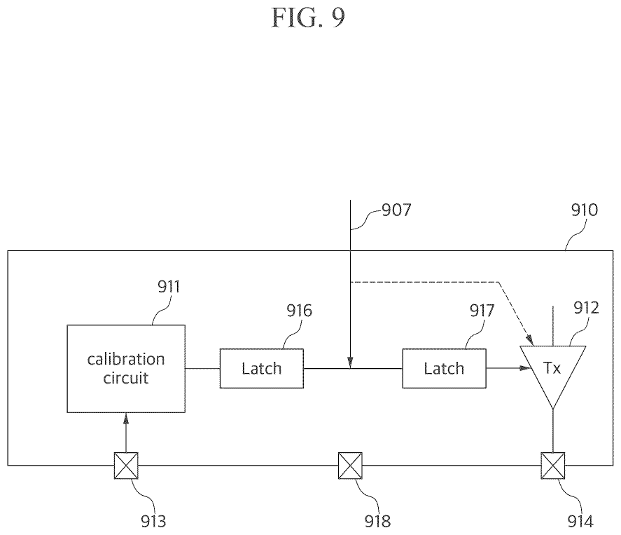

FIG. 9 is a block diagram illustrating an example of a memory device according to some implementations. In FIG. 9, a transmission circuit 912 may identify a first mode or a second mode based on a command 907 received from outside of a memory device 910 and determine whether to switch to the first mode.

For example, the command 907 received from outside may be a success command terminate (SCT) command and/or a success command enable (SCE) command. Each of the SCT command and the SCE command is a command that identifies a predetermined command is in an executable state or in a terminated state regarding an operation of the transmission circuit 912 for predetermined data, and through the SCT command and the SCE command, whether the transmission circuit 912 is in a state of data transmission and reception at present may be identified.

Accordingly, by identifying a state of the transmission circuit 912 through the SCT command and/or the SCE command, whether the memory device 910 is in the first mode or the second mode may be identified separately from a control signal received through an ODT pad 918, or whether to switch to the first mode may be indirectly determined. Specifically, when the SCE command is identified, since a data transmission and reception operation is initiated or to be initiated by the transmission circuit 912, the transmission circuit 912 may determine that the memory device 910 is switched to the first mode. In this case, the SCT command and/or the SCE command may be received from a memory controller outside of the memory device 910.

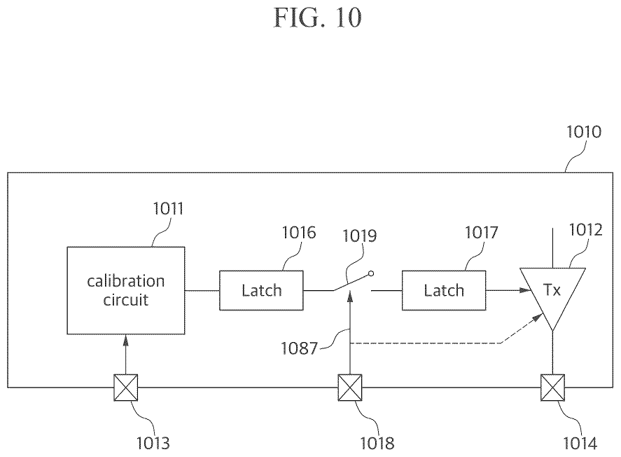

FIG. 10 is a block diagram illustrating an example of a memory device according to some implementations. In FIG. 10, a memory device 1010 may further include a switch 1019 connected between a first latch 1016 and a second latch 1017. In this case, the switch 1019 may be controlled to update a second ZQ code to a first ZQ code. Specifically, when the memory device 1010 is in a second mode, the switch 1019 may be turned on (for example, switched to a closed state) to update the second ZQ code to the first ZQ code. In this case, the switch 1019 may be controlled by a memory controller outside of the memory device 1010.

According to some implementations, even when another memory device is in the first mode by performing a DMA operation, irrelevant thereto, a calibration circuit 1011 included in the memory device 1010 may perform ZQ calibration and store the first ZQ code generated as a result in the first latch 1016. In addition, when the memory device 1010 is determined to be in the second mode by using at least one of a command received from outside and a control signal 1087 received through an ODT pad 1018, the second ZQ code stored in the second latch 1017 may be updated to the first ZQ code by switching the switch 1019 to an on state. Accordingly, the second latch 1017 may transmit the first ZQ code generated as a result of performing the ZQ calibration to a transmission circuit 1012. The transmission circuit 1012 may provide a termination resistance to a DQ pad based on the first ZQ code in the first mode.

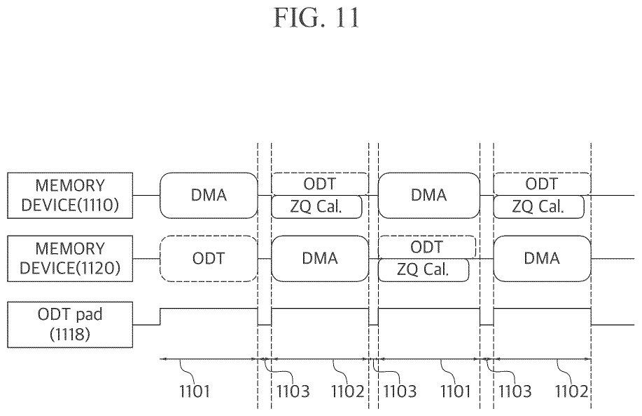

FIG. 11 is a timing diagram of an example of an operation of a memory device according to some implementations. In FIG. 11, it may be identified that efficiency is improved by a first memory device 1110 and a second memory device 1120 performing ZQ calibration. Specifically, a calibration circuit of the first memory device 1110 may be configured to perform the ZQ calibration even in an interval 1102 where a control signal of an ODT pad 1118 is activated (namely, at a high level) by the second memory device 1120 performing a DMA operation.

Specifically, referring to the interval 1102, the calibration circuit of the first memory device 1110 may perform the ZQ calibration in a first mode where an activated signal is applied to the ODT pad 1118. In other words, the calibration circuit of the first memory device 1110 may perform the ZQ calibration in the first mode where the control signal of the ODT pad 1118 is at a high level by the second memory device 1120 performing the DMA operation.

Meanwhile, a ZQ code generated as a result of performing the ZQ calibration may be updated on a transmission circuit in a second mode. In particular, the ZQ code may be updated on the transmission circuit in an interval where a control signal is at a low level 1103 as an ODT is terminated and an inactivated signal is applied to the ODT pad 1118.

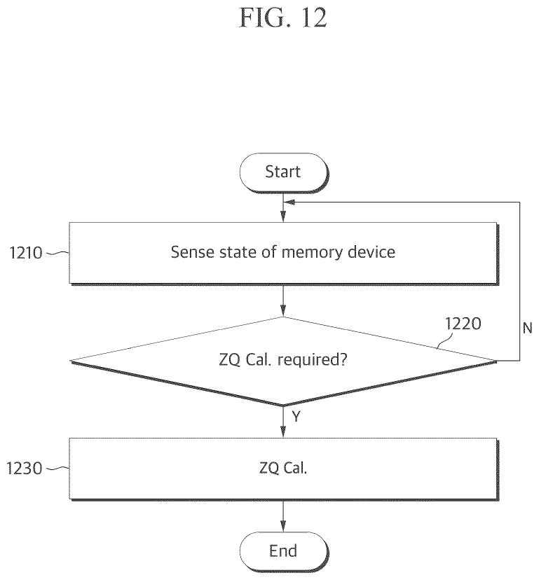

FIG. 12 is a flowchart of an example of an operation method of a memory device according to some implementations. In FIG. 12, in operation 1210, a sub-circuit may sense a state of a memory device. For example, the sub-circuit may generate a status signal indicating the state of the memory device by sensing the state of the memory device.

According to some implementations, the sub-circuit may include at least one of a temperature sensor configured to sense a temperature of the memory device, a voltage sensor configured to sense a voltage of a ZQ pad, and an oscillator generating an oscillating signal having a frequency varying according to the state of the memory device.

In operation 1220, a calibration circuit may determine whether ZQ calibration is required. Specifically, the calibration circuit may compare a value of the status signal to at least one reference value and determine whether to initiate the ZQ calibration based on a comparison result. According to some implementations, the calibration circuit may determine not to initiate the ZQ calibration. In this case, the sub-circuit may generate the status signal indicating the state of the memory device according to operation 1210 again.

In operation 1230, when the calibration circuit determines to initiate the ZQ calibration, the ZQ calibration may be initiated.

According to some implementations, the calibration circuit may identify another memory device performs ZQ calibration based on the voltage of the ZQ pad. In this case, when the calibration circuit identifies that another memory device does not perform the ZQ calibration, the ZQ calibration may be performed.

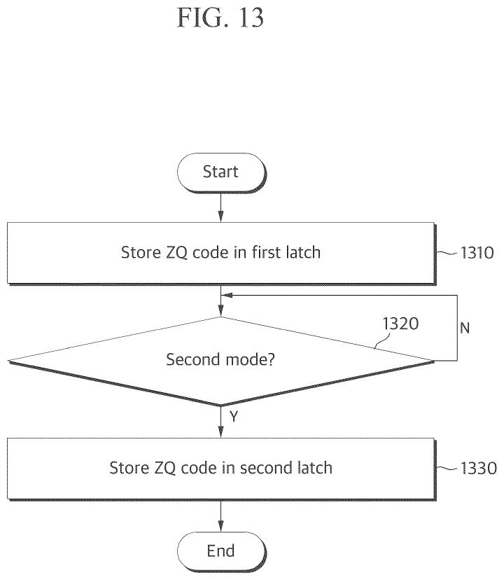

FIG. 13 is a flowchart of an example of an operation method of a memory device according to some implementations. In FIG. 13, in operation 1310, a calibration circuit may store a ZQ code generated based on a ZQ calibration result in a first latch.

In operation 1320, a transmission circuit may determine whether a memory device is in a second mode.

According to some implementations, the transmission circuit may identify a first mode or the second mode of the memory device based on a command received from outside of the memory device. Furthermore, according to some implementations, the transmission circuit may identify the first mode or the second mode of the memory device based on a control signal received through an ODT pad.

According to some implementations, the transmission circuit may determine that the memory device is not in the second mode. In this case, the transmission circuit may determine whether the memory device is in the second mode according to operation 1320 again.

In operation 1330, when the transmission circuit determines that the memory device is in the second mode, a ZQ code may be stored in a second latch.

According to some implementations, the transmission circuit may update the ZQ code pre-stored in the second latch in the second mode to the ZQ code stored in the first latch.

According to some implementations, the transmission circuit may provide a termination resistance to a DQ pad based on the ZQ code in the first mode.

In other words, the calibration circuit may generate the ZQ code by performing the ZQ calibration based on a state of a ZQ pad. In this case, the calibration circuit may initiate the ZQ calibration based on a status signal.

In addition, the transmission circuit may identify the first mode or the second mode based on a command received from outside. Furthermore, the transmission circuit may identify the first mode or the second mode based on a control signal received through the ODT pad. The transmission circuit may provide the termination resistance to the DQ pad based on the ZQ code in the first mode and block the termination resistance from the DQ pad in the second mode.

Furthermore, a sub-circuit may generate the status signal indicating a state of the memory device. As an example, the sub-circuit may sense a temperature of the memory device, sense a voltage of the ZQ pad, or generate an oscillating signal having a frequency varying according to the state of the memory device.

Meanwhile, the calibration circuit may compare a value of the status signal to at least one reference value and determine whether to initiate the ZQ calibration based on a comparison result. Furthermore, the calibration circuit may store a first ZQ code generated based on the ZQ calibration result in the first latch and generate a second ZQ code stored in the second latch as a ZQ code.

In addition, an external device may update the second ZQ code to the first ZQ code in the second mode.

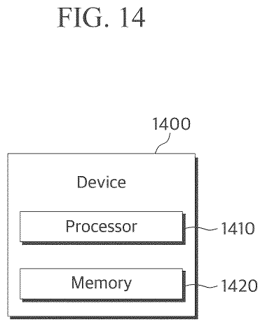

FIG. 14 is a block diagram of an example of a device according to some implementations. The device 1400 of FIG. 14 may be an example of at least one of the host-storage system 10, the host 100, the storage device 200, or the memory device 220 described above.

In FIG. 14, a device 1400 may include a processor 1410 and a memory 1420. The device 1400 described of FIG. 14 only shows elements related to some implementations. In some implementations, other general-purpose elements in addition to elements illustrated in FIG. 14 may further included.

FIG. 14 illustrates a single processor 1410, but the device 1400 may include any number of processors, and each processor may be a single core or a multi core processor, and each processor may embody a reduced instruction set computer (RISC) architecture or a complex instruction set computer (CISC) architecture (among other possibilities), which may be mixed in a desired combination.

The memory 1420 is a hardware that stores a variety of data processed within the device 1400 and may store a program for processing and controlling of the processor 1410.

The memory 1420 may include random access memory (RAM) such as dynamic random access memory (DRAM) and static random access memory (SRAM), read-only memory (ROM), electrically erasable programmable read-only memory (EEPROM), CD-ROM, a blue-ray or another optical disk storage, a hard disk drive (HDD), a solid state drive (SSD) or flash memory.

The processor 1410 controls an entire operation of the device 1400. For example, the processor 1410 may entirely control an input part, a display, a communication part, the memory 1420, and the like by executing programs stored in the memory 1420. The processor 1410, by executing programs stored in the memory 1420, may control an operation in the device 1400.

The processor 1410 may control at least a part of an operation of the device described in FIGS. 1 to 13.

The processor 1410 may be implemented by using at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, and an electrical unit for performing other functions.

In some implementations, the device 1400 may be a server. The server may be implemented as a computer device or a plurality of computer devices providing an instruction, a code, a file, content, service, and the like by communicating through a network.

Meanwhile, the device 1400 may further include a communication part. The communication part may include one or more elements enabling wire/wireless communication with an external server or an external device. For example, the communication part may include at least one of a short-distance communication part, a mobile communication part, and a broadcasting receiving part.

According to some implementations, it is possible to provide a method to relieve a burden of a memory device user and improve integrity of a signal by performing calibration according to a change of a temperature or a voltage without a separate command.

Effects of the present disclosure are not limited to the above-mentioned effects, and other unstated effects may be clearly understood by those of ordinary skill in the art from the appended claims.

An electronic device according to the aforementioned implementations may include a processor, a memory storing and executing program data, and permanent storage such as a disk drive, a communication port communicating with an external device, and a user interface device such as a touch panel, a key, and a button. Methods implemented as a software module or an algorithm may be stored in a computer-readable recording medium as computer-readable codes or program instructions that may be executable in a processor. Here, the computer-readable recording medium are a magnetic storage medium (for example, read-only memory (ROM), random-access memory (RAM), a floppy disk, a hard disk, and the like) and an optical readable medium (for example, CD-ROM, a digital versatile disc (DVD), and the like). The computer-readable recording medium may be distributed to network-connected computer systems so that the computer-readable codes may be stored and executed in a distributed manner. The medium may be readable by a computer, stored in a memory, and executed in a processor.

The present implementations may be illustrated as functional block configurations and various processing steps. The functional blocks may be implemented as multiple hardware or/and software configurations that execute particular functions. For example, some implementations may adopt integrated circuit configurations, such as memory, processing, a logic, and a look-up table, which may execute various functions by the control of one or more microprocessors or other control devices. Similar to elements that may be executed by software programming or software elements, some implementations may be implemented in a programming or scripting language including C, C++, Java, and assembler by including various algorithms implemented as a combination of data structures, processes, routines, or other programming constructs. Functional aspects may be implemented by an algorithm executed in one or more processors. Furthermore, some implementations may adopt the existing art for electronic environment setting, signal processing, and/or data processing, and the like. The terms such as “mechanism,” “element,” “means,” “configuration” may be widely used and not limited to mechanical and physical configurations. The terms may include a meaning of a series of routines of software in association with a processor and the like.

While this disclosure contains many specific implementation details, these should not be construed as limitations on the scope of what may be claimed, equivalents thereof, as well as claims to be described later. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. A memory device comprising:
a calibration circuit connected to a ZQ pad and configured to perform ZQ calibration and generate a ZQ code;
a transmission circuit configured to provide a termination resistance to a DQ pad based on the ZQ code in a first mode and to block the termination resistance from the DQ pad in a second mode; and
at least one sub-circuit configured to generate a status signal indicating a state of the memory device,
wherein the calibration circuit is configured to initiate the ZQ calibration based on the status signal.

2. The memory device of claim 1, wherein the at least one sub-circuit includes at least one of:
a temperature sensor configured to sense a temperature of the memory device;
a voltage sensor configured to sense a voltage of the ZQ pad; or
an oscillator configured to generate an oscillating signal having a frequency varying according to the state of the memory device.

3. The memory device of claim 1, wherein the calibration circuit is configured to compare a value of the status signal to at least one reference value and to determine to initiate the ZQ calibration based on comparing the value of the status signal to the at least one reference value.

4. The memory device of claim 1, wherein the calibration circuit is configured to identify that another memory device performs ZQ calibration based on a voltage of the ZQ pad.

5. The memory device of claim 1, comprising:
a first latch configured to store a first ZQ code received from the calibration circuit; and
a second latch configured to store a second ZQ code provided to the transmission circuit,
wherein the second latch is configured to update the second ZQ code with the first ZQ code in the second mode.

6. The memory device of claim 5, comprising a switch connected between the first latch and the second latch,
wherein the switch is configured to be turned-on in the second mode.

7. The memory device of claim 1, wherein the transmission circuit is configured to determine to switch to the first mode based on a command originated outside the memory device.

8. The memory device of claim 1, wherein the transmission circuit is configured to determine to switch to the first mode based on a control signal received through an on-die termination (ODT) pad.

9. The memory device of claim 8, wherein the calibration circuit is configured to perform the ZQ calibration in the first mode.

10. The memory device of claim 1, wherein the calibration circuit is configured to initiate the ZQ calibration in response to a command originated outside the memory device.

11. The memory device of claim 1, wherein the memory device comprises a flash memory device.

12. An operating method of a memory device, the operating method comprising:
generating a ZQ code by performing ZQ calibration based on a state of a ZQ pad;
providing, in a first mode, a termination resistance to a DQ pad based on the ZQ code;
blocking, in a second mode, the termination resistance from the DQ pad; and
generating a status signal indicating a state of the memory device,
wherein generating the ZQ code comprises initiating the ZQ calibration based on the status signal.

13. The operating method of claim 12, wherein generating the status signal comprises at least one of:
sensing a temperature of the memory device;
sensing a voltage of the ZQ pad; and
generating an oscillating signal having a frequency varying according to the state of the memory device.

14. The operating method of claim 12, wherein initiating the ZQ calibration comprises:
comparing a value of the status signal to at least one reference value; and
determining to initiate the ZQ calibration based on comparing the value of the status signal to the at least one reference value.

15. The operating method of claim 12, wherein generating the ZQ code comprises:
storing a first ZQ code generated based on a result of the ZQ calibration in a first latch;
generating a second ZQ code stored in a second latch as the ZQ code; and
updating the second ZQ code to the first ZQ code in the second mode.

16. The operating method of claim 12, comprising:
receiving a command originated outside the memory device; and
identifying the first mode or the second mode based on the command.

17. The operating method of claim 12, comprising:
receiving a control signal through an ODT pad; and
identifying the first mode or the second mode based on the control signal.

18. A memory device comprising:
a calibration circuit connected to a ZQ pad and configured to perform ZQ calibration and generate a ZQ code; and
a transmission circuit configured to provide a termination resistance to a DQ pad based on the ZQ code in a first mode and to block the termination resistance from the DQ pad in a second mode,
wherein the calibration circuit is configured to perform the ZQ calibration in the first mode.

19. The memory device of claim 18, further comprising:
a first latch configured to store a first ZQ code received from the calibration circuit; and
a second latch configured to store a second ZQ code provided to the transmission circuit,
wherein the second ZQ code is updated to the first ZQ code in the second mode.

20. The memory device of claim 18, wherein the calibration circuit is configured to identify the first mode or the second mode based on at least one of a command originated outside the memory device or a control signal received through an ODT pad.
